(19) United States
(12) Patent Application Publication
(10) Pub. No.: US 2009/0305643 A1
(43) Pub. Date: Dec. 10, 2009

(54) RADIO RECEIVER

(75) Inventors: Anthony Sayers, Redhill Surrey (GB); Robert Fifield, Redhill Surrey (GB)

Correspondence Address: SEED INTELLECTUAL PROPERTY LAW GROUP PLLC, 701 FIFTH AVENUE, SUITE 5400, SEATTLE, WA, 98104-7092, US

(73) Assignee: ST-Ericsson SA, Geneva (CH)

(21) Appl. No.: 12/483,667

(22) Filed: Jun. 12, 2009

Related U.S. Application Data
(63) Continuation-in-part of application No. PCT/IB2007/055000, filed on Dec. 10, 2007.

(30) Foreign Application Priority Data
Dec. 12, 2006 (EP) 06125891.9

(51) Int. Cl. H04B 1/00

(52) U.S. Cl. 455/68

(57) ABSTRACT

A radio receiver (600) in which a local oscillator frequency is selected dependent on the level of a received signal. The received signal may be a wanted signal or an interferer, or the level of both may be measured.

### BACKGROUND

1. Technical Field

This disclosure relates to a radio receiver and to a method of operating a radio receiver.

2. Description of the Related Art

Radio receivers, for example those used with the Global System for Mobile communication (GSM) and the Enhanced Data rates for GSM Evolution (EDGE) systems, are known, see for example FIG. 1. The receiver 100 in FIG. 1 comprises an antenna 102, a band-defining filter 104, a low-noise amplifier 106, two mixers 108a, b, a local oscillator (LO) for providing quadrature related local oscillator signals Sin ω_{L}t and Cos ω_{L}t to the mixers 108a,b, and a complex filter 114 for filtering the quadrature related components of the signal output by the mixers 108a,b.

Such receivers suffer from noise due both to interferer signals passed by a band-defining filter and also due to inherent noise of the electronics. A typical band-defining filter has a pass-band width of between ten and one hundred times the bandwidth of a desired signal. This allows a large number of potential interferers to be present within the band passed by the band defining filter.

Where a non-zero intermediate frequency (IF) is used, there may be a problem due to the “image” of an interfering signal. If the frequency of the interferer is a given amount below the local oscillator frequency, its “image” occurs above the local oscillator frequency by the same amount. Typically, frequencies are shown in diagrams relative to the local oscillator (LO) frequency F_{LO}. Frequencies below the local oscillator frequency are, by convention, held to be negative. Accordingly, the frequency of the interferer is the opposite sign to the frequency of its image, with the same displacement from the LO frequency.

The desired signal is, by convention, held to be at a positive frequency equal to the chosen IF. Thus, in the case where the interferer has a negative frequency, the difference in frequency between the image and the desired signal will be less than that between the interferer and the desired signal. This mechanism enables large magnitude interferers remote from the desired signal frequency effectively to move closer to the desired signal, where their effect will have a greater impact on the desired signal.

Typically, a complex filter 114 is used to reject the image signal. However, this image rejection process is not perfect and a residual image signal remains, as shown in FIG. 2. This can be due to imperfections in the complex filter itself and the elements of the radio receiver that precede it.

In a CMOS radio receiver there are two principal sources of inherent noise as shown in FIG. 3. Thermal noise is the dominant noise mechanism at high frequencies, for example in excess of 100 kHz from an intermediate frequency (IF) of the radio receiver. “1/f” or “flicker” noise has a power density spectrum that is inversely proportional to the operating frequency. Therefore, flicker noise dominates the noise spectrum below about 100 kHz from the IF.

FIG. 4 illustrates noise figures for a receiver with a GSM and two different EDGE channel filters (EDGE1, EDGE2), showing that the noise figure decreases with an increase in IF. For example, when the IF is 100 kHz the noise figure is approximately 7.5 dB, and when the IF is 200 kHz it is approximately 4.2-4.3 dB.

However, this is the case where no interfering signals are present. The presence of an interfering signal causes an image of the interfering signal to be produced. In the example shown in FIG. 5A, the interfering signal occurs at a frequency, F_{LO} −300 kHz with a magnitude X dB, and the desired signal occurs at 100 kHz. The image appears at +300 kHz, closer to the desired signal than the interfering signal itself, although the image signal is attenuated by image rejection to a magnitude X-IR dB, where IR is the magnitude of the image rejection of the receiver. In general, the interfering signal occurs at frequency Fᵢₙₜ and the desired signal occurs at frequency F_{IF}. Accordingly, as F_{IF} increases the desired signal and the image signal of the interferer become closer in frequency.

Specifications of radio systems have increased image rejection requirements for a higher IF because of the image being closer to the desired signal at a higher IF. This is shown in FIG. 5B where, for example, operating the receiver at 200 kHz IF requires between 6 to 12 dB extra image rejection.

A particular problem occurs when an interferer occurs at the image signal frequency. U.S. Pat. No. 6,985,710 describes an image rejection mixer with a variable IF. The IF frequency is selected dependent on the frequency of the interferer to ensure a wide frequency spacing between the image frequency and the local oscillator.

### BRIEF SUMMARY

The present disclosure provides a radio receiver having improved performance.

According to a first aspect of the present disclosure there is provided a radio receiver for receiving a wanted signal. The receiver includes a variable frequency local oscillator for generating a local oscillator signal; a mixer for mixing the local oscillator signal with a received signal; a controller for measuring the level of the received signal and for selecting, in dependence on the measured level, a first local oscillator frequency or a second local oscillator frequency, wherein the second local oscillator frequency is closer than the first local oscillator frequency to the frequency of the wanted signal.

Such a receiver enables its performance to be adapted according to prevailing conditions. The receiver's noise figure, which is best when a high intermediate frequency is used, and image rejection capability, which is best when a low intermediate frequency is used, can be adapted depending on the measured level of the received signal.

Optionally, the controller is adapted to measure the level of the received wanted signal and to select the first local oscillator frequency if the measured level is below a first threshold, and to select the second local oscillator frequency if the measured level is above the first threshold.

This embodiment is simple to implement and enables a high image rejection when the wanted signal is large enough (above the first threshold) for the receiver to operate even in the presence of large 1/f noise, and simultaneously enables a high image rejection by the use of the lower IF. When the wanted signal is below the first threshold, such that 1/f noise must be minimized for acceptable performance, the higher IF is used. In this case, image rejection is reduced, but if an interferer is not present, an acceptable performance is nevertheless possible; if an interferer is present then an acceptable performance may not be possible, but this may be no worse than operating with a low IF and suffering the degradation caused by the 1/f noise.

Optionally, the controller is adapted to measure the level of received unwanted signal and to select the first local oscillator frequency if the measured level is below a second threshold, and to select the second local oscillator frequency if the measured level is above the second threshold.

This embodiment enables a high image rejection by the use of the lower IF when an interferer above the second threshold is present, and a low noise figure, and by the use of a high IF when the interference level is below the second threshold and a high image rejection is not required. If a high level wanted signal is present when the low IF is in use, then acceptable receiver performance may be possible despite the higher 1/f noise. If a low level wanted signal is present when the low IF is in use, then an acceptable performance may not be possible, but this may be no worse than operating with a high IF and suffering the degradation caused by the interferer.

Optionally, the controller is adapted to measure the level of both the received wanted signal and a received unwanted signal, and to select one of the first and second local oscillator frequencies dependent on both measured levels.

This embodiment enables the local oscillator frequency to be selected to optimize the receiver performance for the prevailing signal levels. As an example, bit error rate may be optimized. As another example, where an interferer is not present or is present at only a low level, and the wanted signal has a power large enough to be demodulated in the presence of flicker noise, a low IF may be selected as that can reduce the power consumption of baseband digital hardware.

The receiver may include a variable frequency complex filter for adapting to filter signals when different IF frequencies are selected.

The receiver may comprise a switch for varying the phase of the LO signal supplied to the mixer. The switching of phases supplied to the mixer allows an interferer to be received directly via the variable complex filter at the control processor where the magnitude of the interferer can be determined.

According to a second aspect of the present disclosure there is provided a method of operating a radio receiver that includes steps of: generating a local oscillator signal using a variable frequency local oscillator; mixing the local oscillator signal with a received signal; measuring the level of the received signal; and selecting, in dependence on the measured level, a first local oscillator frequency or a second local oscillator frequency, wherein the second local oscillator frequency is closer than the first local oscillator frequency to the frequency of a wanted signal.

Optionally the method includes measuring a level of the received wanted signal and selecting the first local oscillator frequency if the measured level is below a first threshold, and selecting the second local oscillator frequency if the measured level is above the first threshold.

Optionally the method includes measuring the level of a received unwanted signal, and selecting the first local oscillator frequency if the measured level is below a second threshold, and selecting the second local oscillator frequency if the measured level is above the second threshold.

The disclosure also provides a transceiver that includes a radio receiver according to the disclosure.

The disclosure also provides a mobile communication apparatus that includes a radio receiver according to the disclosure, or a transceiver according to the disclosure.

In accordance with another embodiment of the present disclosure, a circuit is provided that includes a radio receiver for receiving radio signals, the receiver including: a local oscillator structured to generate a local oscillator signal; a mixer structured to mix the local oscillator signal with received radio signals; and a controller coupled to the mixer and the local oscillator and structured to measure a level of the received radio signal and to select a first local oscillator frequency or a second local oscillator frequency in response to the measured level of the received radio signal, the second local oscillator frequency having a frequency that is closer to a frequency of the received radio signal.

In accordance with another aspect of the foregoing embodiment, the controller is structured to measure a level of the received radio signal and to select the first local oscillator frequency when the measured level of the received radio frequency is below a first threshold and to select the second local oscillator frequency when the measured level of the received radio frequency is above the first threshold.

In accordance with another aspect of the foregoing embodiment, the controller is structured to measure the level of a received radio signal that is unwanted and to select the first local oscillator frequency when the measured level of the unwanted received radio signal is below a second threshold and to select the second local oscillator frequency when the measured level of the unwanted radio frequency signal is above the second threshold.

These and other aspects of the present disclosure will be apparent from and elucidated with reference to the embodiments described hereinafter.

### BRIEF DESCRIPTION OF THE SEVERAL VIEWS OF THE DRAWINGS

Embodiments of the present disclosure will now be described, by way of example only, with reference to the accompanying drawings, in which:

FIG. 1 is a radio receiver of a known design;

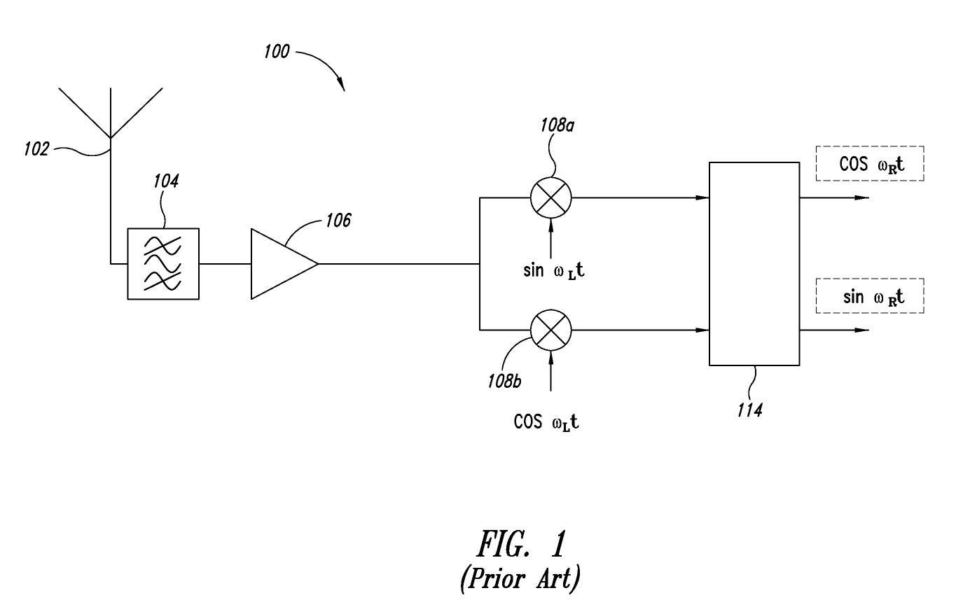

FIG. 2 is a graphical representation of the frequency response of a known complex filter;

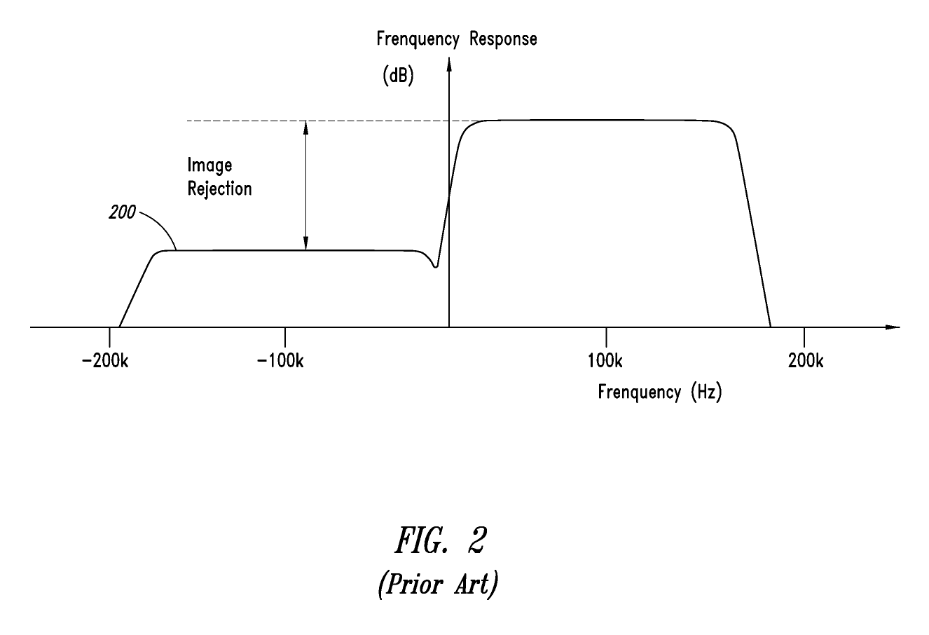

FIG. 3 is a graphical representation of a noise figure of an exemplary CMOS radio receiver of a known design;

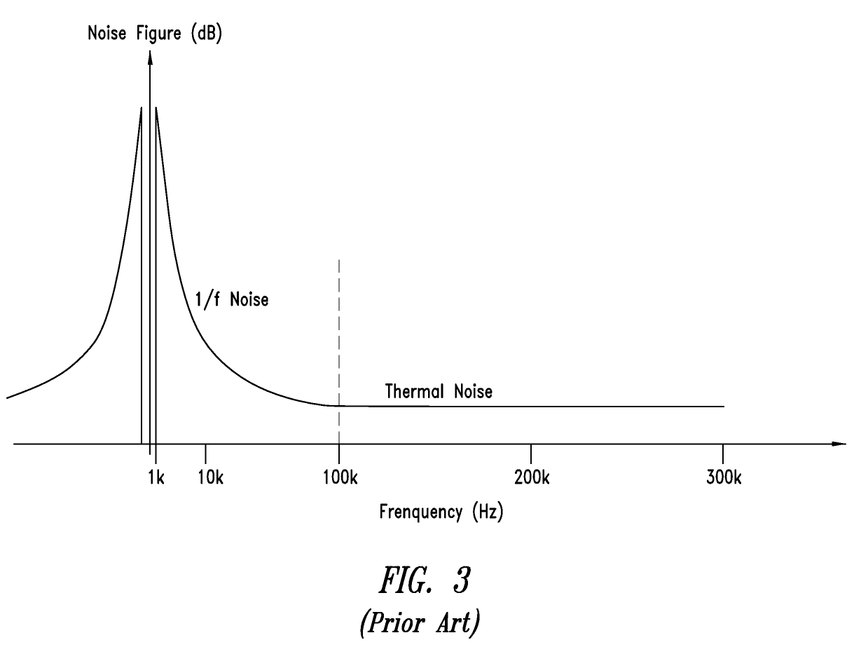

FIG. 4 is a graphical representation of noise figures of a receiver having typical GSM and EDGE filters, noise figure (dB) vs. IF (Hz);

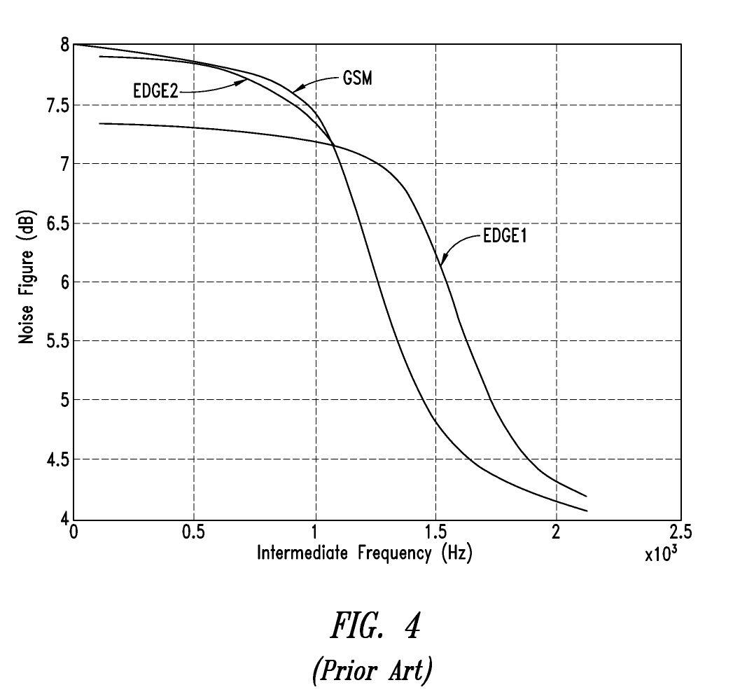

FIG. 5A is a graphical representation of the effect of a strong (XdB) interferer at −300 kHz with respect to an IF of 100 kHz;

FIG. 5B is a graphical representation of required image rejection criteria of a radio receiver, additional image rejection (dB) vs. IF (Hz);

FIG. 6 is a schematic diagram of an embodiment of a radio receiver in accordance with an aspect of the present disclosure;

FIG. 7 is a schematic diagram of a further embodiment of a radio receiver in accordance with an aspect of the present disclosure;

FIG. 8A is a graphical representation of a GSM channel filter with an IF of 100 kHz overlaid on the noise figures of FIG. 3;

FIG. 8B is a graphical representation of a GSM channel filter with an IF of 115 kHz overlaid on the noise figures of FIG. 3; and

FIG. 9 is a flow diagram illustrating a method of operating a radio receiver according to an aspect of the present disclosure.

### DETAILED DESCRIPTION

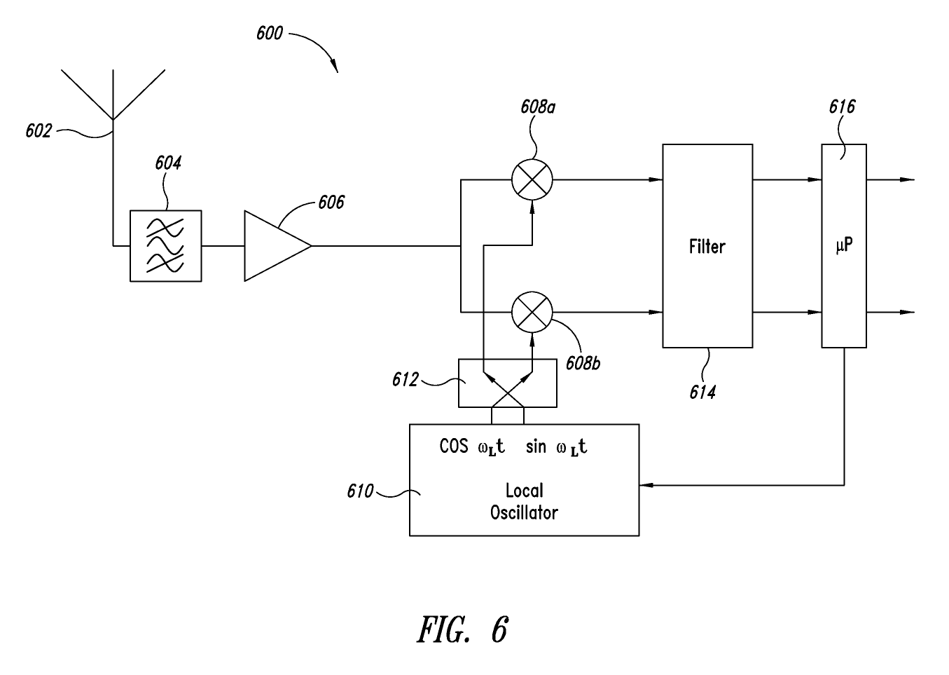

Referring to FIG. 6, a radio receiver 600 is shown to include an antenna 602 coupled to an input of a band-defining filter 604. An output of the band-defining filter 604 is coupled to an input of a low-noise amplifier 606, and an output of the low-noise amplifier 606 is coupled to inputs of two mixers 608a,b. A local oscillator (LO) 610 generates quadrature-related local oscillator signals that are coupled to respective inputs of the two mixers 608a, b via a switch 612 which is arranged for interchanging the signals. Outputs of the mixers 608a, b are coupled to inputs of a variable complex filter 614, and outputs of the variable complex filter 614 are coupled to a control processor 616, which is arranged to control the LO 610 and the switch 612. Typically, the radio receiver 600 will be implemented using CMOS technology.

The antenna 602 receives an incoming radio frequency (RF) signal. The RF signal passes to the band-defining filter 604 where a band of received frequencies are selected for passage to the low noise amplifier 606. Typically, the bandwidth of frequencies passed to the low noise amplifier 606 by the band filter 604 is about ten to one hundred times the bandwidth of a desired signal.

The band of frequencies is amplified by the low noise amplifier 606 and then split into two separate paths.

In a typical arrangement, the LO 610 includes a Fractional-N synthesizer in order to provide a wide range of possible IFs. Should a more limited range of IFs be sufficient, the LO 610 may comprise a phase locked loop (PLL) that is capable of generating a range of frequencies. Initially, the LO 610 generates a LO signal of suitable frequency such that the IF is at a high frequency, for example 200 kHz. Both sine and cosine forms of the LO are generated at the LO 610. The disposition of the switch 612 determines which of the mixers 608A,b receives the sine (sin ω_{L}t) and cosine (cos ω_{L}t) forms of the LO signal. In the arrangement shown in FIG. 6, the upper mixer 608A receives the sine form of the LO signal and the lower mixer 608b receives the cosine form of the LO signal. In an alternative embodiment, instead of using the switch 612 to interchange the quadrature LO signals, one of the sine or cosine forms of the LO signal may be inverted to achieve reversal of the 90° phase offset between the LO signals.

The downshifted signals pass from the mixers 608a, b to the variable complex filter 614. In this embodiment, the complex filter 614 is dynamic in order to allow for variable IFs to be used. Thus, the desired signal is received directly at the output of the complex filter 614, where its power may be measured by the control processor 616.

In order to determine if an interferer is present, for example at 400 kHz when the receiver is operating at an IF of 200 kHz, the disposition of the switch 612 is reversed (or one of the LO signals is inverted). This applies the cosine form of the LO signal to the upper mixer 608a and the sine form of the LO signal to the lower mixer 608b. Typically, this sampling would occur before the arrival of a data packet at the mixers 608a, b. In the case of GSM, this time would be known, because GSM is a time division multiplexed system in which the receiver 600 has a knowledge of when a data packet is due to arrive.

A consequence of this arrangement is that should an interferer be present at, or near, the image frequency, the interferer will now pass through the complex filter 614 to be received directly.

The power, or an indication of power, of the interferer may be measured by the control processor 616 following the complex filter 614. Possible methods of determining the presence and the power of the interferer include measuring the total signal power at each stage of decimation, and monitoring the total signal for a sudden loss of power due to attenuation of the interferer when the LO signals are temporarily swapped. Another possible method is to filter the signal and measure the power levels at certain frequencies.

In one embodiment, in which the power of the wanted signal is measured, if the measured power is below a first threshold level, the control processor 616 controls the LO 610 to select the higher IF frequency by selecting an LO frequency relatively distant from the frequency of the wanted signal. If the measured power is above the first threshold level, the lower IF frequency is selected by selecting an LO relatively close the frequency of the desired signal.

In another embodiment, in which the power of the unwanted signal (i.e., interferer) is measured, if the measured power is below a second threshold level, the control processor 616 controls the LO 610 to select the lower IF frequency by selecting an LO frequency relatively close to the frequency of the wanted signal. If the measured power is above the first threshold level, the higher IF frequency is selected by selecting an LO relatively distant from the frequency of the wanted signal.

In another embodiment, in which the power levels of both the wanted signal and unwanted signal are measured, the control processor 616 controls the LO 610 to select the higher or lower IF frequency by selecting respectively an LO frequency relatively distant from or close to the frequency of the wanted signal, according to whichever is expected to result in the better receiver performance, e.g., bit error rate. Prediction of performance may be based on comparing both the measured wanted and unwanted signal power levels against respective thresholds. As a further example, where the control processor 616 determines that an interferer is not present or is present at only a low level, and the wanted signal has a power large enough to be demodulated in the presence of flicker noise, it may select a low IF because that can reduce the power consumption of baseband digital hardware, such as the variable complex filter 614.

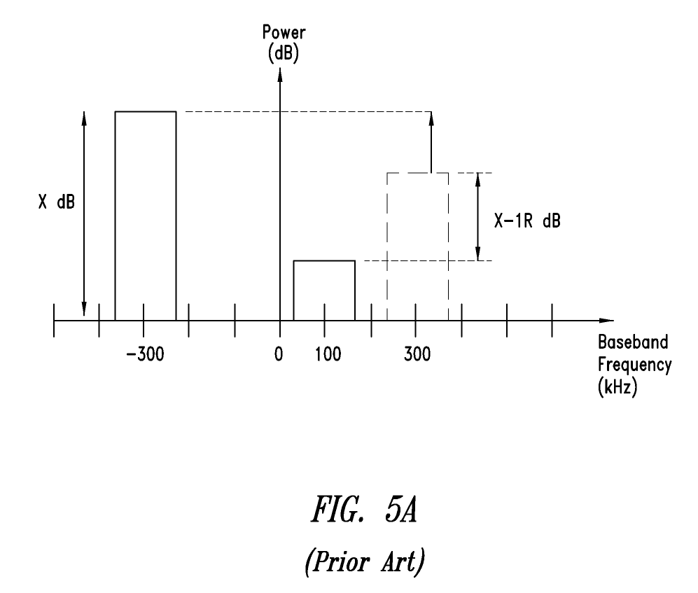

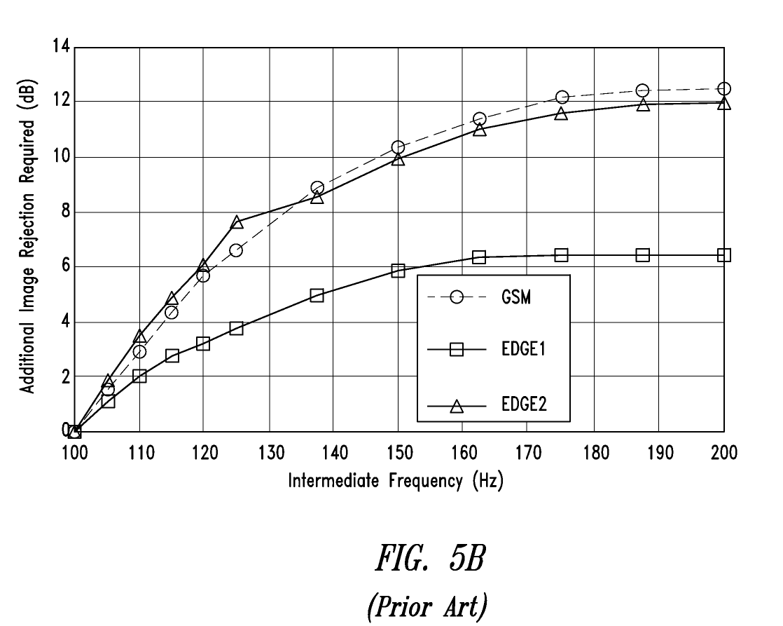

The threshold values will depend on the application to which the receiver 600 is applied, the image rejection capability of the receiver 600 and the size of the interferer. Suitable threshold values for GSM and EDGE operating at various IFs can be determined from FIG. 5B.

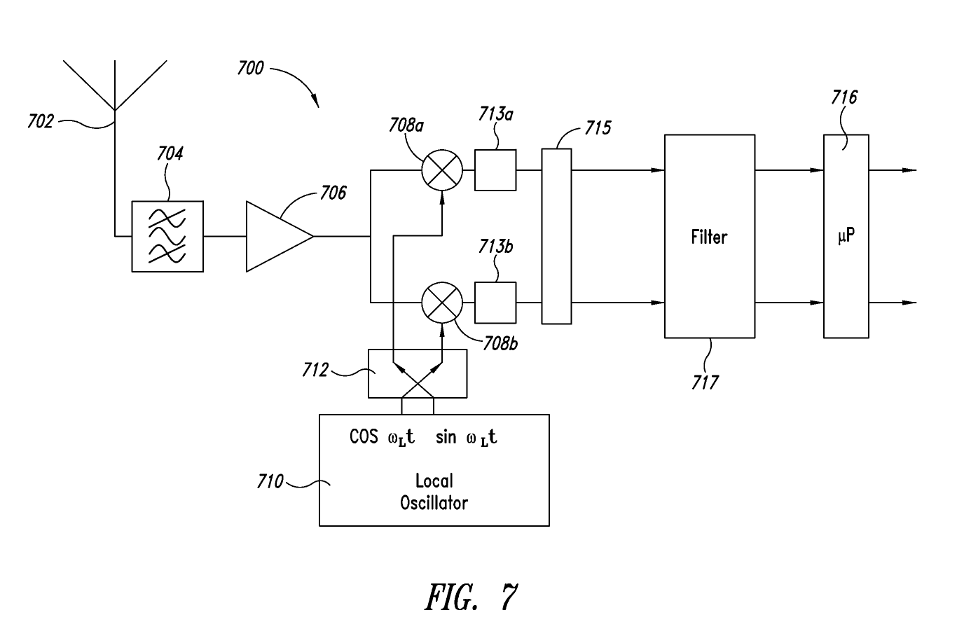

Referring now to FIG. 7, a further embodiment of a radio receiver 700 is similar to that of FIG. 6. Accordingly, elements of the embodiment of FIG. 7 identical to those of FIG. 6 are accorded corresponding reference numerals in the seven hundred series.

The antenna 702, band-defining filter 704, low-noise amplifier 706, mixers 708a, b, local oscillator (LO) 710, and switch 712 operate as previously described in relation to FIG. 6.

Respective ADCs 713a,b follow the mixers 708a, b in order that the downshifted signals can be digitized. The digitized downshifted signals are passed to a processor 715 where they are altered such that the effective IF of the signals is zero. In this embodiment, the altered signals pass to a filter 717 that is optimized to receive signals having an IF of zero. In a further embodiment, a non-zero effective IF can be used and the filter 717 will be optimized accordingly.

The control processor 716 controls the operation of the LO 710 and the switch 712 in response to a measured power of a pre-selected desired signal or an interferer or both as described in relation to the embodiment of FIG. 6.

It will be appreciated that a further embodiment of the present disclosure is envisaged in which a single mixer architecture is employed. In such an embodiment the presence of an interferer can be determined using a super-heterodyne and polyphase filter at the IF frequency.

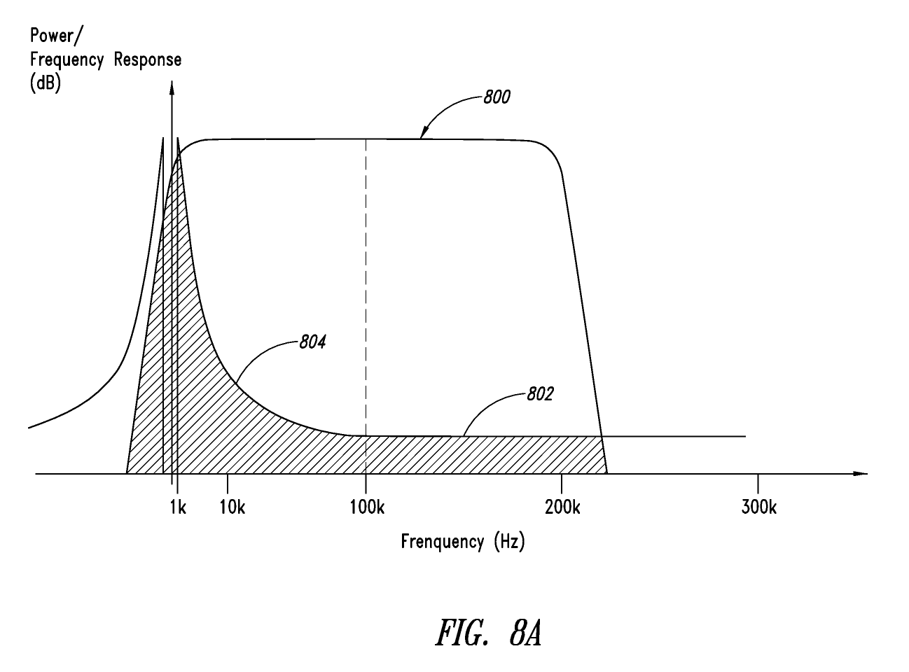

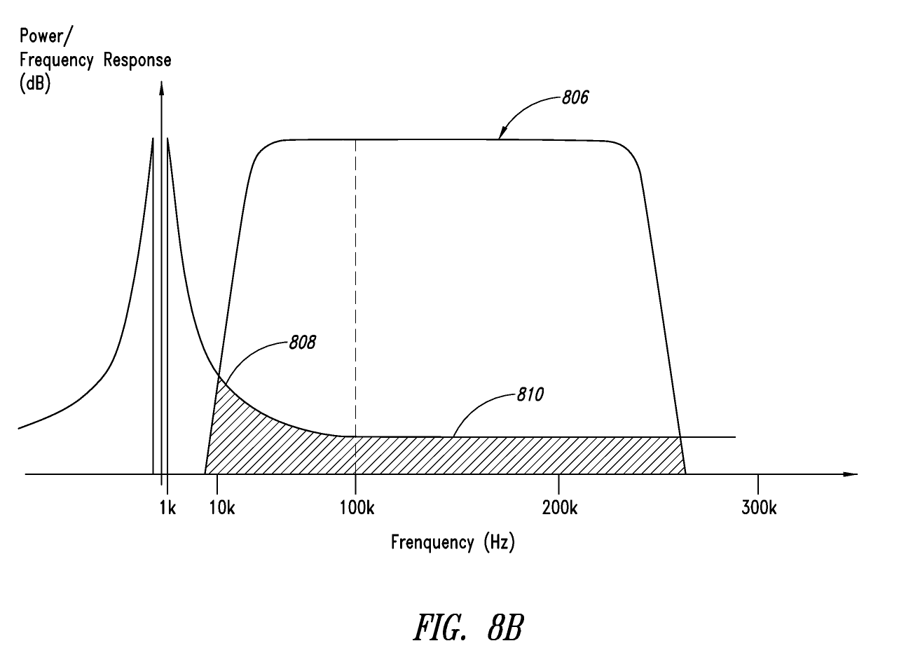

Referring now to FIGS. 8A and 8B, a channel filter window 800 centered on an IF of 100 kHz encompasses both thermal noise 802 and a significant proportion of flicker noise 804. (The channel filter corresponds to the variable complex filter 616,716). The effect of increasing the center point of a filter window 806 to an IF 115 kHz is to remove most of the flicker noise 808 from the filter window 806. Thermal noise 810 is still present within the channel filter window 806.

It will be appreciated that further increases in IF, for example to 200 kHz, will further reduce the contribution of flicker noise to the overall noise figure of a receiver.

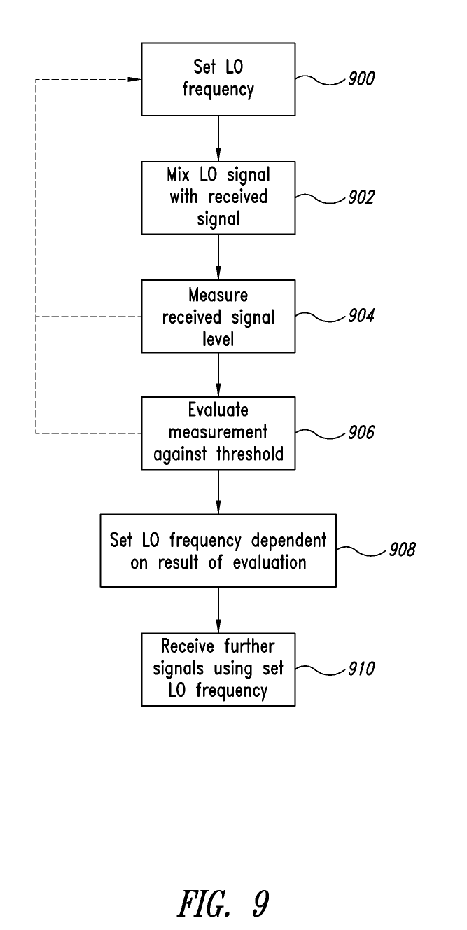

Referring now to FIG. 9, a method of operating a radio receiver comprises, at step 900, setting the frequency of a local oscillator. At step 902 the local oscillator signal is mixed with a received signal; the received signal can be either a wanted signal of an unwanted signal. At step 904 the level of the received signal is measured. At step 906 the measured level is evaluated against a threshold. The threshold may depend on whether the wanted or unwanted signal is being measured at step 904, and it may depend on the local oscillator frequency selected at step 900 for the measurement. Optionally, after step 904 or after step 906 the process may revert to step 900 in order to select a different LO frequency for a further measurement. This may be done in order to obtain additional or alternative measurements in order to arrive at a more reliable measurement of level. After step 906 flow proceeds to step 908 where the local oscillator frequency is selected, dependent on the results of the evaluation of the measured signal level. At step 910 the local oscillator frequency selected at step 908 is used for receiving further signals, for example a data packet. The process may be repeated, for example, periodically or whenever the quality of the received signal is deemed poor.

Optionally more than two LO frequencies may be provided and selected depending on the level of a received signal.

Optionally, a plurality of thresholds may be used for measuring the power of the received signals and for determining which LO frequency to use.

Optionally, the selection of LO frequency may be made between more than two LO frequencies.

Optionally, the measurement of level may be performed with the variable frequency local oscillator set to the first local oscillator frequency or set to the second local oscillator frequency, or set to each in turn. Optionally other local oscillator frequencies may be selected for the measurement.

Where the level of a wanted or unwanted signal is measured with more than one local oscillator frequency, one of the measurements, or a combination of measurements, may be selected as the basis for subsequent selection of the local oscillator frequency.

Although described in relation to a radio receiver implemented using CMOS technology the present disclosure can be implemented in any suitable digital or analogue technology.

Although disclosed with respect to a radio receiver suitable for use in GSM mobile telephony applications the present disclosure is applicable to receivers for other wireless systems, for example, a television receiver, a wireless local area network receiver (WLAN), Universal Wireless Telecommunication Service (UMTS) or the Global Positioning System (GPS).

It will be further appreciated that when used in alternative applications that IFs appropriate to any given application will be used as appropriate to the channel bandwidth of the application.

While various embodiments of the disclosure have been described, it will be apparent to those skilled in the art once given this disclosure that various modifications, changes, improvements and variations may be made without departing from the scope of the disclosure.

In the present specification and claims the word “a” or “an” preceding an element does not exclude the presence of a plurality of such elements. Further, the word “comprising” does not exclude the presence of other elements or steps than those listed.

1. A radio receiver for receiving a wanted signal, comprising:
a variable frequency local oscillator structured to generate a local oscillator signal;
a mixer that mixes the local oscillator signal with a received signal;
a controller structured to measure the level of the received signal and to select, in dependence on the measured level, a first local oscillator frequency or a second local oscillator frequency, wherein the second local oscillator frequency is closer than the first local oscillator frequency to a frequency of the wanted signal.

2. The radio receiver of claim 1, wherein the controller is adapted to measure a level of the received wanted signal, and to select the first local oscillator frequency if the measured level is below a first threshold, and to select the second local oscillator frequency if the measured level is above the first threshold.

3. The radio receiver of claim 1, wherein the controller is adapted to measure the level of a received unwanted signal, and to select the first local oscillator frequency if the measured level is below a second threshold, and to select the second local oscillator frequency if the measured level is above the second threshold.

4. The radio receiver of claim 1, wherein the controller is adapted to measure the level of both the received wanted signal and a received unwanted signal, and to select one of the first and second local oscillator frequencies dependent on both measured levels.

5. The radio receiver of claim 1, comprising a switch for varying the phase of the local oscillator signal supplied to the mixer means.

6. The radio receiver of claim 3, wherein the receiver comprises a variable frequency complex filter for discriminating between wanted and unwanted signals for the measurement of level.

7. The radio receiver of claim 1, wherein the controller is adapted to perform the measurement of level with the variable frequency local oscillator set to one of the first local oscillator frequency and the second local oscillator frequency.

8. The radio receiver of claim 1, wherein the controller is adapted to perform the measurement with the variable frequency local oscillator set to the first local oscillator frequency and set to the second local oscillator frequency.

9. The radio receiver of claim 1, wherein the first local oscillator frequency is in the range 200 kHz±50 kHz.

10. The radio receiver of claim 1, wherein the second local oscillator frequency is in the range 100 kHz±50 kHz.

11. A transceiver, comprising:
a radio receiver, the radio receiver comprising:
a variable frequency local oscillator structured to generate a local oscillator signal;
a mixer that mixes the local oscillator signal with a received signal;
a controller structured to measure the level of the received signal and to select, in dependence on the measured level, a first local oscillator frequency or a second local oscillator frequency, wherein the second local oscillator frequency is closer than the first local oscillator frequency to a frequency of the wanted signal.

12. A mobile communication apparatus comprising a radio receiver, the radio receiver comprising:
a variable frequency local oscillator structured to generate a local oscillator signal;
a mixer that mixes the local oscillator signal with a received signal;
a controller structured to measure the level of the received signal and to select, in dependence on the measured level, a first local oscillator frequency or a second local oscillator frequency, wherein the second local oscillator frequency is closer than the first local oscillator frequency to a frequency of the wanted signal.

13. A method of operating a radio receiver, comprising the steps of:
generating a local oscillator signal using a variable frequency local oscillator;
mixing the local oscillator signal with a received signal;
measuring the level of the received signal; and
selecting, in dependence on the measured level, a first local oscillator frequency or a second local oscillator frequency, wherein the second local oscillator frequency is closer than the first local oscillator frequency to the frequency of a wanted signal.

14. The method of claim 13, comprising measuring the level of the received wanted signal, and selecting the first local oscillator frequency if the measured level is below a first threshold, and selecting the second local oscillator frequency if the measured level is above the first threshold.

15. The method of claim 13, comprising measuring the level of a received unwanted signal, and selecting the first local oscillator frequency if the measured level is below a second threshold, and selecting the second local oscillator frequency if the measured level is above the second threshold.

16. The method of claim 13, comprising measuring the level of both the received wanted signal and a received unwanted signal, and selecting one of the first and second local oscillator frequencies dependent on both measured levels.

17. The method of claim 13, comprising measuring the level with the variable frequency local oscillator set to one of the first local oscillator frequency and the second local oscillator frequency.

18. The method of claim 13, comprising measuring the level with the variable frequency local oscillator set to the first local oscillator frequency and set to the second local oscillator frequency.

19. A circuit, comprising:
a radio receiver for receiving radio signals, the receiver comprising:
a local oscillator structured to generate a local oscillator signal;
a mixer structured to mix the local oscillator signal with received radio signals; and
a controller coupled to the mixer and the local oscillator and structured to measure a level of the received radio signal and to select a first local oscillator frequency or a second local oscillator frequency in response to the measured level of the received radio signal, the second local oscillator frequency having a frequency that is closer to a frequency of the received radio signal.

20. The circuit of claim 19, wherein the controller is structured to measure a level of the received radio signal and to select the first local oscillator frequency when the measured level of the received radio frequency is below a first threshold and to select the second local oscillator frequency when the measured level of the received radio frequency is above the first threshold.

21. The circuit of claim 19, wherein the controller is structured to measure the level of a received radio signal that is unwanted and to select the first local oscillator frequency when the measured level of the unwanted received radio signal is below a second threshold and to select the second local oscillator frequency when the measured level of the unwanted radio frequency signal is above the second threshold.
